(19) United States
(12) Patent Application Publication
(10) Pub. No.: US 2014/0356710 A1
(43) Pub. Date: Dec. 4, 2014

(54) ELECTRODE FOR RECHARGEABLE LITHIUM BATTERY, AND RECHARGEABLE LITHIUM BATTERY INCLUDING ELECTRODE

(71) Applicant: Samsung SDI Co., Ltd., Yongin-si (KR)

(72) Inventors: Byung-Joo Chung, Yongin-si (KR); Eon-Mi Lee, Yongin-si (KR)

(73) Assignee: Samsung SDI Co., Ltd., Yongin-si (KR)

(21) Appl. No.: 14/174,208

(22) Filed: Feb. 6, 2014

(30) Foreign Application Priority Data
May 28, 2013 (KR) 10-2013-0060469

(51) Int. Cl. H01M 4/62; H01M 4/133; H01M 10/0525; H01M 4/134

(52) U.S. Cl. CPC H01M 4/622; H01M 4/134; H01M 4/133; H01M 10/0525
USPC 429/217

(57) ABSTRACT

In an aspect, an electrode for a rechargeable lithium battery including a current collector and an active material layer positioned on the current collector, wherein the active material layer includes an active material and a binder, the binder includes an acryl-based compound including a repeating unit is provided.

### INCORPORATION BY REFERENCE TO ANY PRIORITY APPLICATIONS

Any and all applications for which all foreign or domestic priority claim is identified in the Application Data Sheet as filed with the present application are hereby incorporated by reference under 37 CFR 1.57. For example, this application claims priority to and the benefit of Korean Patent Application No. 10-2013-0060469 filed in the Korean Intellectual Property Office on May 28, 2013, the disclosure of which is incorporated herein by reference in its entirety.

### BACKGROUND

1. Field

This disclosure relates to an electrode for a rechargeable lithium battery and rechargeable lithium battery including the electrode.

2. Description of the Related Technology

A rechargeable lithium battery includes positive and negative electrodes including a material that can reversibly intercalate/deintercalate lithium ions as positive and negative active materials and an organic electrolyte solution or a polymer electrolyte solution charged between the positive and negative electrodes.

Typically, the positive and negative electrodes intercalate and deintercalate lithium ions and produce electrical energy through oxidation and reduction reactions. As for a positive active material for a lithium rechargeable battery, a lithium-transition metal oxide being capable of intercalating lithium such as LiCoO₂, LiMn₂O₄, LiNi₁₋ₓCoₓO₂ (0<x<1), and the like has been used. As for a negative active material for a lithium rechargeable battery, various carbon-based materials such as artificial graphite, natural graphite, and hard carbon capable of intercalating and deintercalating lithium ions have been used.

A battery having high energy density may require a negative active material having high theoretical capacity density. Accordingly, Si, Sn, and Ge alloyed with lithium and an oxide thereof and an alloy thereof have drawn consideration for inclusion in batteries requiring high energy density. In particular, a Si-based negative active material has very high charge capacity and is may be applied to a high-capacity battery. However, the Si-based negative active material may expand from about 300% to about 400% during charge and discharge cycle.

Accordingly, a binder capable of effectively controlling expansion of the Si-based negative active material is desirable.

The above information disclosed in this Background section is only for enhancement of understanding of the background of the disclosure, and therefore, it may contain information that does not form the prior art already know in this country to a person of ordinary skill in the art.

### SUMMARY

One embodiment provides an electrode for a rechargeable lithium battery being capable of enduring expansion of an active material and having excellent rate capability, cycle-life characteristics and initial efficiency.

Another embodiment provides a rechargeable lithium battery including the same.

In one embodiment, provided is an electrode for a rechargeable lithium battery that includes a current collector and an active material layer positioned on the current collector, wherein the active material layer includes an active material and a binder, the binder includes an acryl-based compound including a repeating unit represented by the following Chemical Formula 1, and the acryl-based compound is included in an amount of about 1.5 wt % to about 4.5 wt % based on the total amount of the active material layer.

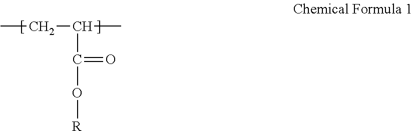

wherein in Chemical Formula 1, R may be an alkali metal.

In some embodiments, R may be lithium, sodium, or a combination thereof.

In some embodiments, the acryl-based compound may further include a repeating unit represented by Chemical Formula 2, and the acryl-based compound may include about 90 mol % to about 99.5 mol % of the repeating unit represented by Chemical Formula 1 and about 0.5 mol % to about 10 mol % of the repeating unit represented by Chemical Formula 2.

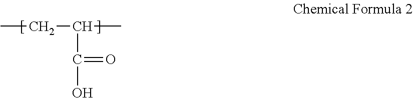

In some embodiments, the acryl-based compound may have pH ranging from about 6 to about 8.5.

In some embodiments, the acryl-based compound may have a viscosity average molecular weight (Mv) of about 100,000 g/mol to about 800,000 g/mol. In some embodiments, the acryl-based compound may include a first acryl-based compound having a viscosity average molecular weight of about 10,000 g/mol to about 400,000 g/mol and a second acryl-based compound having a viscosity average molecular weight of about 500,000 g/mol to about 1,500,000 g/mol.

In some embodiments, the active material may include Si, SiOₓ, a Si—C composite, Si-Q alloy, graphite, or a combination thereof. In some embodiments, x may be in the range of 0<x<2, and Q may be an alkali metal, an alkaline-earth metal, Group 13 to 16 elements, a transition element, a rare earth element, or a combination thereof but not Si.

In some embodiments, the binder may further include at least one selected from polyvinyl alcohol, carboxyl methylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin and nylon as well as the binder including a alkali metal polyacrylate salt.

In some embodiments, the binder may be included in an amount of about 0.5 wt % to about 50 wt % based on the total amount of the active material layer.

In some embodiments, the active material layer may further include a conductive material.

In some embodiments, a rechargeable lithium battery including the electrode and an electrolyte is provided.

In some embodiments, the electrode for a rechargeable lithium battery may be stable, may be capable of enduring expansion of an active material, and a rechargeable lithium battery including the same may have improved rate capability, cycle-life characteristics, and initial efficiency.

### BRIEF DESCRIPTION OF THE DRAWING

FIG. 1 is a schematic view of a rechargeable lithium battery according to one embodiment.

### DETAILED DESCRIPTION

Hereinafter, embodiments of the present disclosure are described in detail. However, these embodiments are exemplary, and this disclosure is not limited thereto.

As used herein, when a definition is not otherwise provided, the term “substituted” may refer to substitution with a C1 to C30 alkyl group; a C2 to C30 alkenyl group, a C2 to C30 alkynyl group, a C1 to C10 alkylsilyl group; a C3 to C30 cycloalkyl group; a C6 to C30 aryl group; a C1 to C30 heteroaryl group; a C1 to C10 alkoxy group; a silane group; an alkylsilane group; an alkoxysilane group; an amine group; an alkylamine group; an arylamine group; or a halogen, instead of hydrogen of a compound.

As used herein, when a definition is not otherwise provided, the term “hetero” may refer to one selected from N (nitrogen), O (oxygen), S (sulfur), and P (phosphorus).

As used herein, when a definition is not otherwise provided, the term “alkyl group” may refer to “a saturated alkyl group” without any alkenyl group or alkynyl; or “an unsaturated alkyl group” including at least one alkenyl group or alkynyl group. The “alkenyl group” may refer to a substituent having at least one carbon-carbon double bond of at least two carbons, and the “alkynyl group” may refer to a substituent having at least one carbon-carbon triple bond of at least two carbons. The alkyl group may be a branched, linear, or cyclic alkyl group.

In some embodiments, the alkyl group may be a C1 to C20 alkyl group, for example, a C1 to C6 lower alkyl group, a C7 to C10 medium-sized alkyl group, or a C11 to C20 higher alkyl group.

For example, a C1 to C4 alkyl group may have 1 to 4 carbon atoms in an alkyl chain and may be selected from methyl, ethyl, propyl, iso-propyl, n-butyl, iso-butyl, sec-butyl, and t-butyl.

Examples of the alkyl group may be a methyl group, an ethyl group, a propyl group, an isopropyl group, a butyl group, an isobutyl group, a t-butyl group, a pentyl group, a hexyl group, an ethenyl group, a propenyl group, a butenyl group, a cyclopropyl group, a cyclobutyl group, a cyclopentyl group, a cyclohexyl group, and the like.

The “aromatic group” may refer to a cyclic substituent including all elements having a p-orbital which form conjugation. Examples of the aromatic group may include an aryl group and a heteroaryl group.

The “aryl group” may refer to a monocyclic or fused ring (i.e., a plurality of rings sharing adjacent pairs of carbon atoms).

The “heteroaryl group” may refer to an aryl group including 1 to 3 hetero atoms selected from the group consisting of N (nitrogen), O (oxygen), S (sulfur), and P (phosphorus). When the heteroaryl group is a fused ring, each ring may include 1 to 3 hetero atoms.

As used herein, when a definition is not otherwise provided, the term “copolymerization” may refer to block copolymerization, random copolymerization, graft copolymerization, or alternating copolymerization, and the term “copolymer” may refer to a block copolymer, a random copolymer, a graft copolymer, or an alternating copolymer.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In some embodiments, an electrode for a rechargeable lithium battery includes a current collector and an active material layer positioned on the current collector, wherein the active material layer includes an active material and a binder, the binder includes an acryl-based compound including a repeating unit represented by Chemical Formula 1, and the acryl-based compound may be included in an amount of about 1.5 wt % to about 4.5 wt % based on the total amount of the active material layer.

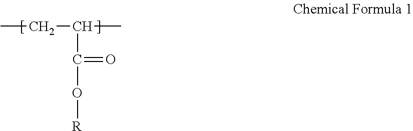

wherein in Chemical Formula 1, R may be an alkali metal.

In some embodiments, the electrode is capable of enduring expansion of an active material, is stable, and has improved cycle-life characteristics and initial efficiency. Particularly, when the acryl-based compound is included within the above ranges, initial efficiency may be improved.

The acryl-based compound including the repeating unit represented by the above Chemical Formula 1 may be referred to as polyacrylic acid alkali metal salt (alkali metal polyacrylate). A polyacrylic acid alkali metal salt is a polyacrylic acid substituting hydrogen of a carboxyl group (—COOH) with an alkali metal (i.e., carboxyl group of polyacrylic acid is substituted with an alkali metal).

In some embodiments, the alkali metal may be a monovalent cation metal that belongs to Group 1 of Periodic Table 1, such as lithium, sodium, potassium, rubidium, cesium, francium, and the like.

In the above Chemical Formula 1, R may be, specifically lithium, sodium, or a combination thereof. In some embodiments, the acryl-based compound may be, for example, lithium polyacrylate), sodium polyacrylate, or a combination thereof.

In some embodiments, the acryl-based compound may be prepared by adding hydroxide of an alkali metal to polyacrylic acid. For example, lithium polyacrylate may be prepared by adding LiOH.H₂O to a polyacrylic acid aqueous solution.

In the acryl-based compound, an alkali metal may be included in a range from about 90% to about 100%, and specifically about 95% to about 100% of the potential inclusion sites. An inclusion site may be a carboxylate moiety that is formed by treating a precursor polymer including carboxylic acid moieties with a base where the alkali metal would be a metal cation ion associated with the corresponding carboxylate anion. In this case, cycle-life characteristics and initial efficiency of a rechargeable lithium battery may be improved.

In some embodiments, the acryl-based compound may further include a repeating unit represented by Chemical Formula 2, and the acryl-based compound may include about 90 mol % to about 99.5 mol % of the repeating unit represented by Chemical Formula 1 and about 0.5 mol % to about 10 mol % of a repeating unit represented by Chemical Formula 2.

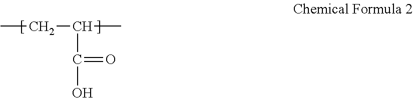

In some embodiments, the acryl-based compound may have pH ranging from about 6 to about 8.5. When the acryl-based compound has pH within the above range, a binder including the acryl-based compound may effectively control expansion of an active material and realize excellent initial efficiency and cycle-life characteristics of a rechargeable lithium battery. The pH may be measured by using a pH measurement device generally used in the art to which the present invention belongs.

In some embodiments, the acryl-based compound may have a viscosity average molecular weight (Mv) of about 100,000 g/mol to about 800,000 g/mol, and specifically about 100,000 g/mol to about 500,000 g/mol.

When the acryl-based compound has a viscosity average molecular weight within the range, a binder including the acryl-based compound may effectively control expansion of an active material and realize excellent initial efficiency and cycle-life characteristics of a rechargeable lithium battery.

In some embodiments, the acryl-based compound may include more than two kinds of acryl-based compounds having different viscosity average molecular weights. In some embodiments, the binder may include a first acryl-based compound having a viscosity average molecular weight of about 10,000 g/mol to about 400,000 g/mol and a second acryl-based compound having a viscosity average molecular weight of about 500,000 g/mol to about 1,500,000 g/mol. Herein, the binder including the acryl-based compound may effectively control expansion of an active material.

In some embodiments, the binder including the acryl-based compound may be used with an organic solvent and also with an aqueous solvent such as water, an alcohol-based solvent, and the like. In other words, the binder may be an organic binder or an aqueous binder. When the binder is used with an aqueous solvent, the binder may be environmentally-friendly.

In some embodiments, the active material may include Si, SiOₓ, a Si—C composite, Si-Q alloy, graphite, or a combination thereof. In some embodiments, x may be in the range of 0<x<2, and Q may be an alkali metal, an alkaline-earth metal, Group 13 to 16 elements, a transition element, a rare earth element, or a combination thereof but not Si. Specific examples of the Q may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Tr, Pd, Pt, Cu, Ag, Au, Zn, Cd, B, Al, Ga, Sn, In, Tl, Ge, P, As, Sb, Bi, S, Se, Te, Po, or a combination thereof.

When the active material is applied to a rechargeable lithium battery, a high-capacity rechargeable lithium battery may be realized. However, the active material is about 300% to about 400% expanded during the charge and discharge and may deteriorate stability or cycle-life characteristics of a rechargeable lithium battery. When the active material is used with the binder according to one embodiment of the present invention, the binder may well endure expansion of the active material and work as a buffer layer. Accordingly, a rechargeable lithium battery including the binder shows excellent cycle-life characteristics as well as high-capacity.

For example, a binder such as styrene-butadiene rubber (SBR), carboxyl methyl cellulose (CMC), and the like is applied to a negative electrode, a negative active material including greater than or equal to about 5 wt % of Si may not realize performance of a rechargeable lithium battery at all. When the Si is included in an amount of about 3% or about 1.6%, the negative active material may remarkably deteriorate cycle-life characteristic of a rechargeable lithium battery. However, the above-described binder may realize very excellent cycle-life characteristics and initial efficiency of a rechargeable lithium battery when Si is included in an amount of greater than or equal to about 5% as well as in a small amount.

In some embodiments, the binder may further include at least one selected from polyvinyl alcohol, carboxyl methylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, and nylon. In this case, adherence of the binder may be improved.

In some embodiments, the binder may be included in an amount of about 0.5 wt % to about 50 wt %, specifically about 0.5 wt % to about 40 wt %, about 0.5 wt % to about 30 wt %, about 0.5 wt % to about 20 wt %, or about 0.5 wt % to about 10 wt % based on the total amount of the active material layer. Within the above ranges, the electrode may realize excellent adherence and may control expansion of an active material effectively.

In some embodiments, the active material layer may further include a conductive material.

In some embodiments, the conductive material improves electrical conductivity of the negative electrode. Any electrically conductive material may be used, unless it causes a chemical change. Examples of the conductive material include at least one selected from a carbon-based material of natural graphite, artificial graphite, carbon black, acetylene black, ketjen black, a carbon fiber, and the like; a metal-based material such as a metal powder or a metal fiber including copper, nickel, aluminum, silver, and the like; a conductive a polymer such as a polyphenylene derivative; or a mixture thereof.

In some embodiments, the conductive material may be used in an amount of about 0.5 wt % to about 10 wt % based on the total amount of the active material layer. Within the above ranges, the electrode for a rechargeable lithium battery may have excellent electrical conductivity and may control expansion of an active material effectively.

In some embodiments, the electrode for a rechargeable lithium battery may be a negative electrode. When the binder including the acryl-based compound is applied to a negative electrode along with a negative active material including silicon (Si), excellent effects may be obtained.

In some embodiments, the current collector may be any current collector without a particular limit if it does not cause a chemical change and has high conductivity. In some embodiments, the current collector may be about 3 μm to about 500 μm thick but is not limited thereto.

In some embodiments, the current collector applied to a negative electrode may be a copper foil, a nickel foil, a stainless steel foil, a titanium foil, a nickel foam, a copper foam, a polymer substrate coated with a conductive metal, and combinations thereof.

In some embodiments, the current collector applied to a positive electrode may be a stainless steel, aluminum, nickel, titanium, fired carbon, or aluminum or stainless steel that is surface-treated with carbon, nickel, titanium, silver, and the like.

In some embodiments, a rechargeable lithium battery including the electrode for a rechargeable lithium battery, and an electrolyte is provided.

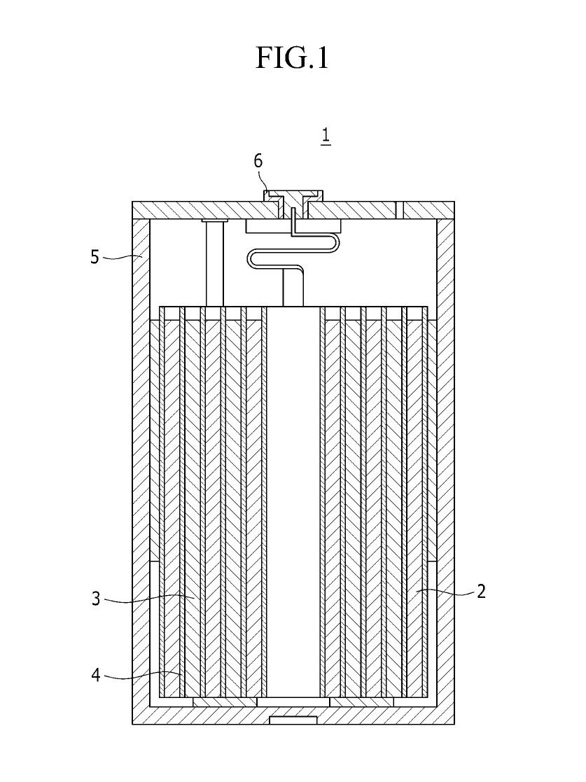

FIG. 1 is a schematic view of a representative structure of a rechargeable lithium battery according to one embodiment. As shown in FIG. 1, the rechargeable lithium battery 1 includes a positive electrode 3, a negative electrode 2, and a separator 4 interposed between the positive electrode 3 and negative electrode 2, an electrolyte impregnated therein, a battery case 5 including the foregoing members, and a sealing member 6 sealing the battery case 5.

When the above-described electrode is used as a negative electrode, the positive electrode may include a positive active material that is a compound (lithiated intercalation compound) being capable of intercalating and deintercallating lithium.

Specifically, at least one composite oxide of lithium and a metal of cobalt, manganese, nickel, or a combination thereof may be used, and specific examples thereof may be a compound represented by one of the following chemical formulae.

LiₐA_{1-b}R_{b}D¹₂ (0.90≦a≦1.8 and 0≦b≦0.5);

LiₐE_{1-b}R_{b}O_{2-c}D¹_{c} (0.90≦a≦1.8, 0≦b≦0.5 and 0≦c≦0.05);

LiE_{2-b}R_{b}O_{4-c}D¹_{c} (0≦b≦0.5, 0≦c≦0.05);

LiₐNi_{1-b-c}Co_{b}R_{c}D¹_{α} (0.90≦a≦1.8, 0≦b≦0.5, 0≦c≦0.05 and 0≦α≦2);

LiₐNi_{1-b-c}Co_{b}R_{c}O_{2-α}Z_{α} (0.90≦a≦1.8, 0≦b≦0.5, 0≦c≦0.05 and 0≦α≦2);

LiₐNi_{1-b-c}Co_{b}R_{c}O_{2-α}Z₂ (0.90≦a≦1.8, 0≦b≦0.5, 0≦c≦0.05 and 0≦α≦2);

LiₐNi_{1-b-c}Mn_{b}R_{c}D_{α} (0.90≦a≦1.8, 0≦b≦0.5, 0≦c≦0.05 and 0≦α≦2);

LiₐNi_{1-b-c}Mn_{b}R_{c}O_{2-α}Z_{α} (0.90≦a≦1.8, 0≦b≦0.5, 0≦c≦0.05 and 0≦α≦2);

LiₐNi_{1-b-c}Mn_{b}R_{c}O_{2-α}Z₂ (0.90≦a≦1.8, 0≦b≦0.5, 0≦c≦0.05 and 0≦α≦2);

LiₐNi_{b}E_{c}G_{d}O₂ (0.90≦a≦1.8, 0≦b≦0.9, 0≦c≦0.5 and 0.001≦d≦0.1);

LiₐNi_{b}Co_{c}Mn_{d}GeO₂ (0.90≦a≦1.8, 0≦b≦0.9, 0≦c≦0.5, 0≦d≦0.5 and 0.001≦e≦0.1);

LiₐNiG_{b}O₂ (0.90≦a≦1.8 and 0.001≦b≦0.1);

LiₐCoG_{b}O₂ (0.90≦a≦1.8 and 0.001≦b≦0.1);

LiₐMnG_{b}O₂ (0.90≦a≦1.8 and 0.001≦b≦0.1);

LiₐMn₂G_{b}O₄ (0.90≦a≦1.8 and 0.001≦b≦0.1); QO₂; QS₂; LiQS₂; V₂O₅; LiV₂O₅; LiTO₂;

LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A may be Ni, Co, Mn, or a combination thereof; R may be Al, Ni, Co, Mn, Cr, Fe, Mg, Sr, V, a rare earth element, or a combination thereof; D¹ may be O, F, S, P, or a combination thereof; E may be Co, Mn, or a combination thereof; Z may be F (fluorine), S (sulfur), P (phosphorus), or a combination thereof; G may be Al, Cr, Mn, Fe, Mg, La, Ce, Sr, V, or a combination thereof; Q may be Ti, Mo, Mn, or a combination thereof; T may be Cr, V, Fe, Sc, Y, or a combination thereof; and J may be V, Cr, Mn, Co, Ni, Cu, or a combination thereof.

In some embodiments, the positive electrode may further include a binder or a conductive material. In some embodiments, the binder may be the binder described above, or polyvinylalcohol, carboxyl methylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

In some embodiments, the conductive material and current collector are the same as described above.

In some embodiments, the negative electrode and the positive electrode may be manufactured by a method including mixing an active material, a binder, or the like in a solvent to prepare an electrode composition, and coating the electrode composition on a current collector. In some embodiments, the solvent for a positive electrode may be N-methylpyrrolidone, and the solvent for a negative electrode may be water or N-methyl pyrrolidone.

In some embodiments, the electrolyte includes a non-aqueous organic solvent and a lithium salt.

In some embodiments, the non-aqueous organic solvent serves as a medium for transmitting ions taking part in the electrochemical reaction of a battery.

In some embodiments, the non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, 1,1-dimethylethyl acetate, methylpropinonate, ethylpropinonate, γ-butyrolactone, decanolide, valerolactone, mevalonolactone, caprolactone, and the like. In some embodiments, the ether-based solvent may include dibutyl ether, tetraglyme, diglyme, dimethoxyethane, 2-methyltetrahydrofuran, tetrahydrofuran and the like, and the ketone-based solvent may include cyclohexanone, and the like. In some embodiments, the alcohol-based solvent may include ethanol, isopropyl alcohol, and the like. In some embodiments, the aprotic solvent include nitriles such as R—CN (wherein R is a C2 to C20 linear, branched, or cyclic hydrocarbon group, and may include a double bond, an aromatic ring, or an ether bond), amides such as dimethylformamide, dioxolanes such as 1,3-dioxolane, sulfolanes, and the like.

In some embodiments, the non-aqueous organic solvent may be used singularly or in a mixture, when the organic solvent is used in a mixture, the mixture ratio may be controlled in accordance with a desirable battery performance.

In some embodiments, the carbonate-based solvent is prepared by mixing a cyclic carbonate and a linear carbonate. In some embodiments, the cyclic carbonate and the linear carbonate are mixed together in the volume ratio of about 1:1 to about 1:9. Within this range, performance of electrolyte may be improved.

In some embodiments, the non-aqueous organic solvent may include a mixture of the carbonate based solvent and an aromatic hydrocarbon based organic solvent. The carbonate-based solvent and the aromatic hydrocarbon-based organic solvent are mixed together in a volume ratio of about 1:1 to about 30:1.

In some embodiments, the aromatic hydrocarbon-based organic solvent may be an aromatic hydrocarbon-based compound represented by the following Chemical Formula A.

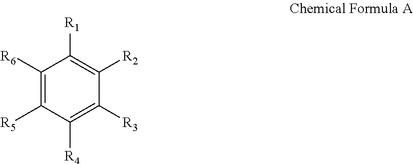

wherein, in Chemical Formula A, R₁ to R₆ are independently hydrogen, a halogen, a C1 to C10 alkyl group, a C1 to C10 haloalkyl group, or a combination thereof.

In some embodiments, the aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

In some embodiments, the non-aqueous electrolyte may further include vinylene carbonate or an ethylene carbonate-based compound represented by Chemical Formula B in order to improve cycle-life of a battery.

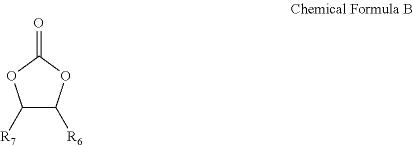

wherein, in Chemical Formula B, R₇ and R₈ are independently, hydrogen, a halogen, cyano group (CN), a nitro group (NO₂), or a C1 to C5 fluoroalkyl group, provided that at least one of R₇ and R₈ is a halogen, a cyano group (CN), a nitro group (NO₂) or a C1 to C5 fluoroalkyl group.

Examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the vinylene carbonate or the ethylene carbonate-based compound used to improve cycle life may be adjusted within an appropriate range.

The lithium salt is dissolved in the non-aqueous solvent and supplies lithium ions in a rechargeable lithium battery, and basically operates the rechargeable lithium battery and improves lithium ion transfer between positive and negative electrodes. In some embodiments, the lithium salt include at least one supporting salt selected from LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers of 1 to 20, respectively), LiCl, LiI, LiB(C₂O₄)₂ (lithium bis(oxalato) borate), or a combination thereof. In some embodiments, the lithium salt may be used in a concentration of about 0.1M to about 2.0M. When the lithium salt is included within the above concentration range, it may electrolyte performance and lithium ion mobility due to optimal electrolyte conductivity and viscosity.

In some embodiments, the electrode may include a separator. In some embodiments, the separator may include any materials commonly used in the conventional lithium battery as long as separating a negative electrode from a positive electrode and providing a transporting passage of lithium ion. In other words, it may have a low resistance to ion transport and an excellent impregnation for electrolyte. For example, it may be selected from glass fiber, polyester, polyethylene, polypropylene, polytetrafluoroethylene (PTFE), or a combination thereof. It may have a form of a non-woven fabric or a woven fabric. For example, for the lithium ion battery, polyolefin-based polymer separator such as polyethylene, polypropylene or the like is mainly used. In order to ensure the heat resistance or mechanical strength, a coated separator including a ceramic component or a polymer material may be used. Selectively, it may have a mono-layered or multi-layered structure.

Hereinafter, the above-described aspects of the present disclosure are illustrated in more detail with reference to examples. However, these examples are exemplary, and the present disclosure is not limited thereto.

### EXAMPLES

### Example 1

### Preparation of Binder

Polyacrylic acid (PAA) having My of 450,000 (Sigma-Aldrich Co. Ltd., St Louis Mo.) and water were measured in a weight ratio of 1:9 and slowly agitated by using a magnetic bar until the PAA was completely dissolved in the water. The dissolution occurred at a temperature of less than or equal to 60° C. Subsequently, LiOH.H₂O was added to the solution to adjust its pH into 8, thereby preparing a binder (lithium polyacrylate).

### Manufacture of Negative Electrode

A negative active material slurry was prepared by mixing 80 wt % of a Si-alloy (3M, St. Paul, Minn.) and 14 wt % of plate-type graphite, SFG6, as a negative active material, 4 wt % of the binder, and 2 wt % of ketjen black as a conductive material in an water solvent. The negative active material slurry was coated on a copper foil, dried at 110° C. to evaporate water, and compressed, manufacturing a 56 μm-thick negative electrode. The negative electrode was manufactured to have a 16 mm-size disk shape.

### Manufacture of Rechargeable Lithium Battery Cell (Half-Cell)

Using the negative electrode, a lithium metal as a counter electrode, a polypropylene separator, and an electrolyte solution prepared by mixing ethylene carbonate (EC):diethyl carbonate (DEC):fluoro ethylene carbonate (FEC) in a ratio 5:70:25 and adding LiPF₆ in a concentration of 1.5 mol/L to the mixed solvent, a rechargeable lithium battery cell was fabricated.

### Example 2

A rechargeable lithium battery cell was manufactured according to the same method as Example 1 except for mixing 80 wt % of a Si-alloy and 15 wt % of plate-type graphite, SFG6, as a negative active material, 3 wt % of the binder, and 2 wt % of ketjen black as a conductive material.

### Example 3

A rechargeable lithium battery cell was manufactured according to the same method as Example 1 except for mixing 81 wt % of a Si-alloy and 15 wt % of plate-type graphite, SFG6, as a negative active material, 2 wt % of the binder, and 2 wt % of ketjen black as a conductive material.

### Example 4

A rechargeable lithium battery cell was manufactured according to the same method as Example 1 except for adjusting pH into 7 when the binder was prepared.

### Example 5

A rechargeable lithium battery cell was manufactured according to the same method as Example 1 except for adjusting pH into 6 when the binder was prepared.

### Comparative Example 1

A rechargeable lithium battery cell was manufactured according to the same method as Example 1 except for using 82 wt % of a Si-alloy and 15 wt % of plate-type graphite, SFG6, as a negative active material, 1 wt % of the binder, and 2 wt % of ketjen black as a conductive material.

### Comparative Example 2

A rechargeable lithium battery cell was manufactured according to the same method as Example 1 except for using 77 wt % of a Si-alloy and 11 wt % of plate-type graphite, SFG6, as a negative active material, 10 wt % of the binder, and 2 wt % of ketjen black as a conductive material.

### Comparative Example 3

A rechargeable lithium battery cell was manufactured according to the same method as Example 1 except for using 72 wt % of a Si-alloy and 6 wt % of plate-type graphite, SFG6, as a negative active material, 20 wt % of the binder, and 2 wt % of ketjen black as a conductive material. 3.

### Comparative Example 4

A rechargeable lithium battery cell was manufactured according to the same method as Example 1 except for using 2 wt % of a styrene-butadiene rubber (SBR) and 2 wt % of carboxylmethyl cellulose (CMC) as a binder.

Composition of the negative active materials according to Examples 1 to 5 and Comparative Examples 1 to 4 are provided in Table 1.

### Experimental Example 1

### Capacity Characteristics

The rechargeable lithium battery cells according to Examples and Comparative Examples were charged and discharged at 0.1 C within a voltage range of 1.5V to 0.01V and measured regarding discharge capacity, and the results are provided in Table 1.

### Experimental Example 2

### Cycle-Life Characteristics

The rechargeable lithium battery cells according to Examples and Comparative Examples were measured regarding a capacity ratio of capacity at 50^{th} cycle relative to capacity at 1^{St} cycle under a condition of 1C, and the results are provided in Table 1.

### Experimental Example 3

### Initial Efficiency

The rechargeable lithium battery cells according to Examples and Comparative Examples were charged and discharged at 0.1 C and then, charge capacity and discharge capacity were measured, ratios of the discharge capacity relative to the charge capacity were calculated, and the results are provided in Table 1.

TABLE 1

| | | Examples | | | | | Comparative Examples | | | |
|---|---|---|---|---|---|---|---|---|---|---|
| | | 1 | 2 | 3 | 4 | 5 | 1 | 2 | 3 | 4 |
| (A) Active material | (A-1) Si alloy (3M) | 80 | 80 | 81 | 80 | 80 | 82 | 77 | 72 | 80 |
| | (A-2) graphite SFG6 | 14 | 15 | 15 | 14 | 14 | 15 | 11 | 6 | 14 |
| (B) Binder | (B-1) Li-PAA | 4 | 3 | 2 | | | 1 | 10 | 20 | |
| | (B-2) Li-PAA | | | | 4 | | | | | |
| | (B-3) Li-PAA | | | | | 4 | | | | |
| | (B-4) SBR | | | | | | | | | 2 |
| | (B-5) CMC | | | | | | | | | 2 |

| | | | | | | | | | |
|---|---|---|---|---|---|---|---|---|---|
| (C) Conductive material | 2 | 2 | 2 | 2 | 2 | 2 | 2 | 2 | 2 |
| Discharge capacity (mAh/g) | 852 | 846 | 837 | 851 | 843 | — | 823 | 811 | — |
| Retention capacity (%) | 91 | 89 | 87 | 90 | 89 | — | 83 | 85 | — |
| @50 cycle | | | | | | | | | |
| Initial efficiency (%) | 91 | 90 | 89 | 88 | 86 | — | 86 | 86 | — |

Referring to Table 1, the rechargeable lithium battery cells according to Examples have excellent capacity characteristic, cycle-life characteristics, and initial efficiency compared with the rechargeable lithium battery cells according to Comparative Examples. In particular, the rechargeable lithium battery cells according to Examples showed improved initial efficiency compared with the rechargeable lithium battery cells according to Comparative Examples.

While this disclosure has been described in connection with what is presently considered to be practical exemplary embodiments, it is to be understood that the disclosure is not limited to the disclosed embodiments and is intended to cover various modifications and equivalent arrangements included within the spirit and scope of the appended claims. Therefore, the aforementioned embodiments should be understood to be exemplary but not limiting the present disclosure in any way.

In the present disclosure, the terms “Example,” “Comparative Example” and “Experimental Example” are used arbitrarily to simply identify a particular example or experimentation and should not be interpreted as admission of prior art. It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. An electrode for a rechargeable lithium battery, comprising
a current collector and an active material layer positioned on the current collector,
the active material layer comprises an active material and a binder,
the binder comprises an acryl-based compound including a repeating unit represented by Chemical Formula 1, and
the acryl-based compound is included in an amount of about 1.5 wt % to about 4.5 wt % based on the total amount of the active material layer: 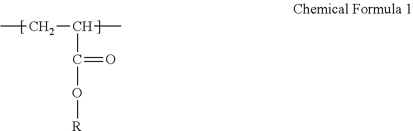
wherein, R is an alkali metal.

2. The electrode for a rechargeable lithium battery of claim 1, wherein, in Chemical Formula 1, R is lithium, sodium, or a combination thereof.

3. The electrode for a rechargeable lithium battery of claim 1, wherein
the acryl-based compound further comprises a repeating unit represented by Chemical Formula 2, and
the acryl-based compound comprises about 90 mol % to about 99.5 mol % of the repeating unit represented by the above Chemical Formula 1 and about 0.5 mol % to about 10 mol % of the repeating unit represented by Chemical Formula 2:

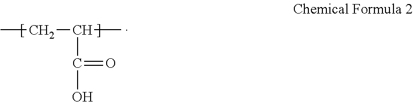

4. The electrode for a rechargeable lithium battery of claim 1, wherein the acryl-based compound has pH ranging from about 6 to about 8.5.

5. The electrode for a rechargeable lithium battery of claim 1, wherein the acryl-based compound has a viscosity average molecular weight (Mv) of about 100,000 g/mol to about 800,000 g/mol.

6. The electrode for a rechargeable lithium battery of claim 1, wherein the acryl-based compound comprises a first acryl-based compound having a viscosity average molecular weight of about 10,000 g/mol to about 400,000 g/mol and a second acryl-based compound having a viscosity average molecular weight of about 500,000 g/mol to about 1,500,000 g/mol.

7. The electrode for a rechargeable lithium battery of claim 1,
wherein the active material comprises Si, SiOₓ, a Si—C composite, a Si-Q alloy, graphite, or a combination thereof,
wherein x is in the range of 0<x<2, and Q is an alkali metal, an alkaline-earth metal, Group 13 to 16 elements, a transition element, a rare earth element, or a combination thereof but not Si.

8. The electrode for a rechargeable lithium battery of claim 1, wherein the binder further comprises at least one selected from polyvinyl alcohol, carboxyl methylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin and nylon.

9. The electrode for a rechargeable lithium battery of claim 1, wherein the binder is included in an amount of about 1.5 to about 5 wt % based on the total amount of the active material layer.

10. The electrode for a rechargeable lithium battery of claim 1, wherein the active material layer further comprises a conductive material.

11. The electrode for a rechargeable lithium battery of claim 1, wherein the electrode is a negative electrode.

12. A rechargeable lithium battery, comprising
the electrode according to claim 1; and
an electrolyte.

13. The rechargeable lithium battery of claim 12, wherein, in Chemical Formula 1, R is lithium, sodium, or a combination thereof.

14. The rechargeable lithium battery of claim 12, wherein
the acryl-based compound further comprises a repeating unit represented by Chemical Formula 2, and
the acryl-based compound comprises about 90 mol % to about 99.5 mol % of the repeating unit represented by the above Chemical Formula 1 and about 0.5 mol % to about 10 mol % of the repeating unit represented by Chemical Formula 2:

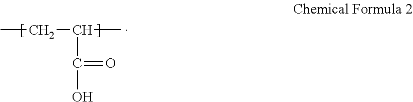

15. The rechargeable lithium battery of claim 12, wherein the acryl-based compound has pH ranging from about 6 to about 8.5.

16. The rechargeable lithium battery of claim 12, wherein the acryl-based compound has a viscosity average molecular weight (Mv) of about 100,000 g/mol to about 800,000 g/mol.

17. The rechargeable lithium battery of claim 12, wherein the acryl-based compound comprises a first acryl-based compound having a viscosity average molecular weight of about 10,000 g/mol to about 400,000 g/mol and a second acryl-based compound having a viscosity average molecular weight of about 500,000 g/mol to about 1,500,000 g/mol.

18. The rechargeable lithium battery of claim 12,
wherein the active material comprises Si, SiOₓ, a Si—C composite, a Si-Q alloy, graphite, or a combination thereof,
wherein x is in the range of 0<x<2, and Q is an alkali metal, an alkaline-earth metal, Group 13 to 16 elements, a transition element, a rare earth element, or a combination thereof but not Si.

19. The rechargeable lithium battery of claim 12, wherein the binder is included in an amount of about 0.5 wt % to about 50 wt % based on the total amount of the active material layer.
